(19) United States
(12) Patent Application Publication
(10) Pub. No.: US 2004/0167662 A1
(43) Pub. Date: Aug. 26, 2004

(54) Expansion of an automated data storage system

(75) Inventors: Brian Gerard Goodman, Tucson, AZ (US); Leonard George Jesionowski, Tucson, AZ (US); Michael Philip McIntosh, Tucson, AZ (US); Robin Daniel Roberts, Tucson, AZ (US); Staley Bert Slawson, Tucson, AZ (US); Raymond Yardy, Tucson, AZ (US)

Correspondence Address: Allen K. Bates, IBM Corporation, 90A/9032-1, 9000 S. Rita Road, Tucson, AZ, 85744, US

(73) Assignee: International Business Machines Corporation

(21) Appl. No.: 10/375,713

(22) Filed: Feb. 24, 2003

(51) Int. Cl. G06F 7/00

(52) U.S. Cl. 700/213

(57) ABSTRACT

Disclosed are a system, a method, and a computer program product to provide for the expansion of an automated data storage library by the use of a multi-purpose frame. When the library is expanded, the multi-purpose frame functions as a service bay for the accessor. The multi-purpose frame that functions as a service bay is easily converted to a supplementary storage frame, when the library is expanded, to accommodate additional data storage media shelves and/or data storage drives. Because the multi-purpose frame is easily converted for use as either a service bay or a supplementary storage frame the relocation of library frames is avoided, thus simplifying and improving the expansion of the library.

### CROSS-REFERENCES TO RELATED APPLICATIONS

The present application is related to application Ser. No. ______, entitled “SYSTEM AND METHOD OF PROVIDING AND RELOCATING A PORTABLE STORAGE CANISTER IN AN AUTOMATED DATA STORAGE LIBRARY”, Docket # TUC9-2002-0073, filed on an even date herewith, the disclosure of which is hereby incorporated by reference in its entirety.

### TECHNICAL FIELD

The present invention relates to library systems for dynamic information storage or retrieval. More particularly, the invention concerns a system to provide for the expansion of an automated data storage library by adding one or more library frames to the existing library structure. The added frames are designed to function as service bays or storage frames.

### BACKGROUND OF THE INVENTION

Automated data storage libraries are known for providing cost effective storage and retrieval of large quantities of data. Automated data storage libraries provide a means for storing data on data storage media that are not permanently mounted in data storage drives, and that are stored on storage shelves inside the library. Many automated data storage libraries are expandable by adding storage modules that may also contain additional drives. In addition, automated data storage libraries may support more than one accessor for improved performance and/or improved reliability. Two basic approaches to the use of multiple accessors in data storage libraries are commonly used. In one case, each module may contain an accessor with a “pass through” port that allows a cartridge to be moved from one module (or frame) to another. A problem with this approach is that a failure of one accessor could prevent access to part or all of the data storage media. In the second case, two or more accessors share the entire space of data storage media so that any accessor could access any data storage cartridge. This approach offers the advantage of any accessor in the system having access to all of the data storage media in the library. If the accessors share a common mechanical path then one accessor may push another accessor out of the way should it become inoperable. Prior art libraries that use this approach generally have a service bay at each end of the library. The service bay acts as a garage for holding the accessor away from the normal operating space during service or when the other accessor needs to gain access to data storage media or drives that are close in proximity to the service bay. One problem with this approach is that when the library is expanded, the service bay has to be removed and then reattached at the end of the library. This can cause additional down time and added expense when expanding an automated data storage library.

The robotic accessors used to manipulate the cartridges are typically required to access a test station or service bay that is located within the confines of the library to test and/or calibrate the cartridge grippers (e.g., for the type of cartridge used in the library). Some libraries use dedicated storage shelves that are located within the normal operational space of the library. These dedicated storage shelves may occupy space that could otherwise be used for user storage, or they may be dedicated diagnostic shelves that never contain user media. In dual accessor libraries, one problem with this approach is that library operation may have to be interrupted in order to calibrate or test a gripper. This is because the accessor performing the calibration or test operation may be in the way of the other accessor.

Other libraries may use a special dedicated service area with fixed shelves or features. For example, dual accessor libraries commonly use two of these dedicated service areas, with one service area being located at each end of the library. This allows one of the accessors to calibrate or test its grippers without interfering with the operation of the other accessor. A problem with this approach is that these fixed features cannot be easily modified because they are fixed in place. For example, if a media type is added to or removed from a mixed media library, then special tools may be required to modify the fixed service area. Thus, some service bays are not portable since they are dedicated to their positions because of other equipment present in the system.

Relocating such types of service bays is a lengthy and cumbersome task. Whenever the library is reconfigured to add additional frames to the system, the service bay typically is relocated to the new frame on the end of the library. In order to relocate the service bay, the entire library must be shut down, disassembled to uninstall the service bay, and then reconfigured and reassembled with the service bay in the new frame. Although this system and method of relocating a service bay in a library is workable, an improvement would be desirable.

Therefore, there is a need to improve automated data storage libraries to accommodate expansion.

### SUMMARY OF THE INVENTION

It is an object of the present invention to provide for the expansion of an automated data storage library by the use of a multi-purpose frame that is designed to function interchangeably as a service bay or a supplementary storage frame.

Disclosed are a system, a method, and a computer program product to provide for the expansion of an automated data storage library by the use of a multi-purpose frame. When the library is expanded the multi-purpose frame functions as a service bay for the accessor. In this capacity the service bay functions as a garage for holding the accessor when it is necessary to move the accessor away from the normal operating space. The accessor may reside in the service bay during maintenance, repair, testing or inactivity of the accessor. In a dual accessor library system the service bay may be used to contain one accessor when the other accessor needs to gain access to data storage media or drives that are close in proximity to the service bay or a storage frame. The multi-purpose frame that functions as a service bay is easily converted to a supplementary storage frame when the library is expanded to accommodate additional data storage media shelves and/or data storage drives. Because the multi-purpose frame is easily converted for use as either a service bay or a supplementary storage frame the relocation of library frames is avoided, thus simplifying and improving the expansion of the library.

In a first embodiment, the library is expanded from a configuration that does not include a service bay by the attachment of a multi-purpose frame. The multi-purpose frame functions as a service bay after the expansion and may be used for storage, service, or testing of the library accessor.

In a second embodiment the library is expanded from the configuration of the first embodiment described above to include a second robot accessor. The first accessor and second accessor are configured to be moveably disposed throughout all of the frames of the expanded library. This enables the multi-purpose frame to be used for storage, service, or testing of either the first or second accessor.

In a third embodiment the library is expanded from a configuration that includes one or more storage frames, one or more service bays, and two accessors. In this embodiment the library is expanded to include a multi-purpose frame that will function as a service bay. The resulting expanded library consists of the multi-purpose frame attached to an existing service bay. In addition, one of the services bays of the original configuration is configured as a supplementary storage frame. A supplementary storage frame operates in an equivalent manner as a storage frame. Both of the accessors are configured to be moveably disposed throughout all of the frames of the expanded library. Further expansions of the library are also simplified because a new multi-purpose frame would become the new service bay and the previous service bay becomes the new supplementary storage frame. In this way, frames do not have to be removed and then reattached. This saves a significant amount of time and cost.

This invention may be combined with the copending application entitled “SYSTEM AND METHOD OF PROVIDING AND RELOCATING A PORTABLE STORAGE CANISTER IN AN AUTOMATED DATA STORAGE LIBRARY” which is hereby incorporated by reference in its entirety, to further simplify the library expansion when mixed media support is provided in the automated data storage library. The above referenced copending application provides the capability for a service bay to be configured for one storage media type while testing media of another type in the same service bay, away from the normal operation of the library.

For a more detailed understanding of the present invention, reference may be made to the following detailed description taken in conjunction with the accompanying drawings.

### BRIEF DESCRIPTION OF THE DRAWINGS

FIG. 1 is a block diagrammatic representation of an automated data storage library controller.

FIG. 2 illustrates an automated data storage library composed of a left hand service bay, multiple storage frames and a right hand service bay.

FIG. 3 shows an minimum configuration of the library composed of one storage frame.

FIG. 4 illustrates an embodiment of a data storage library which employs a distributed system of modules with a plurality of processor nodes.

FIG. 5 illustrates an expanded automated data storage library with a multi-purpose frame attached to the left side of an existing storage frame (a), or with the multi-purpose frame attached to the right side of the existing storage frame (b).

FIG. 6 is a flow chart showing the steps to expand a library, to include a service bay, by attaching a multi-purpose frame.

FIG. 7 is a flow chart showing the steps to expand a library from a initial configuration that includes one or more storage frames and one or more service bays.

### DETAILED DESCRIPTION OF THE PREFERRED EMBODIMENTS

This invention is described in preferred embodiments in the following description. The preferred embodiments are described with reference to the Figures. While this invention is described in conjunction with the preferred embodiments, it will be appreciated by those skilled in the art that it is intended to cover alternatives, modifications, and equivalents as may be included within the spirit and scope of the invention as defined by the appended claims.

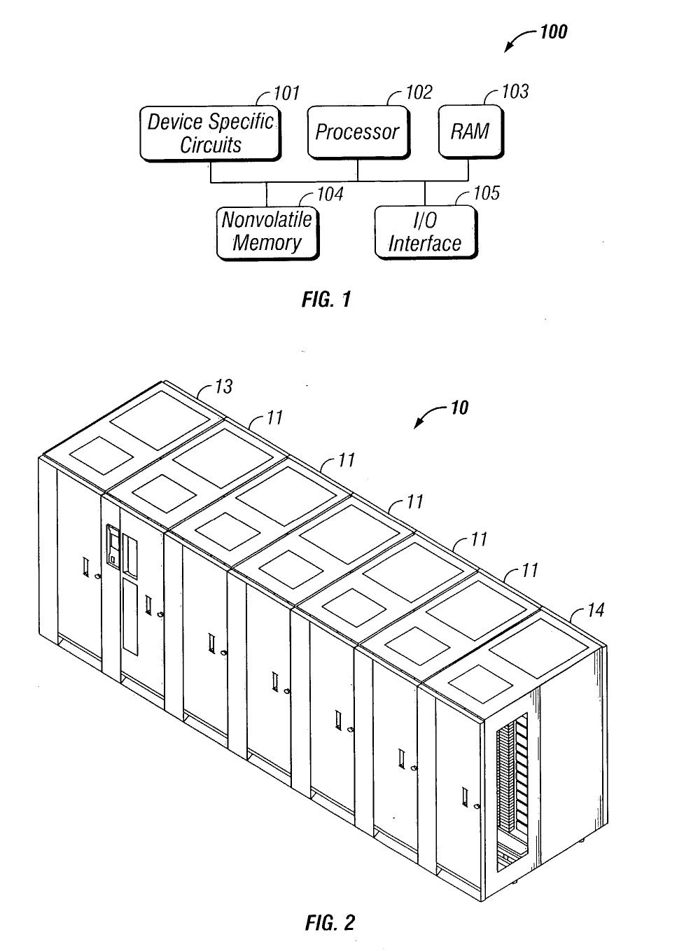

An automated data storage library typically contains one or more library controllers to direct the operation of the automated data storage library. The library controller may take many different forms and may comprise an embedded system, a distributed control system, a personal computer, workstation, etc. FIG. 1 shows a typical library controller 100 with a processor 102, RAM (Random Access Memory) 103, nonvolatile memory 104, device specific circuits 101, and I/O interface 105. Alternatively, the RAM 103 and/or nonvolatile memory 104 may be contained in the processor 102 as could the device specific circuits 101 and I/O interface 105. The processor 102 may comprise an off the shelf microprocessor, custom processor, FPGA (Field Programmable Gate Array), ASIC (Application Specific Integrated Circuit), discrete logic, etc. The RAM 103 is typically used to hold variable data, stack data, executable instructions, etc. The nonvolatile memory 104 may comprise any type of nonvolatile memory such as EEPROM (Electrically Erasable Programmable Read Only Memory), flash PROM (Programmable Read Only Memory), battery backup RAM, hard disk drive, etc. The nonvolatile memory 104 is typically used to hold the executable firmware and any nonvolatile data. The I/O interface 105 is a communication interface that allows the processor 102 to communicate with devices external to the controller. Examples may comprise serial interfaces such as RS-232 or USB (Universal Serial Bus), SCSI (Small Computer Systems Interface), FC-AL (Fibre Channel-Arbitrated Loop), etc. The device specific circuits 101 provide additional hardware to enable the library controller 100 to perform unique functions such as motor control of a cartridge gripper, etc. The device specific circuits 101 may comprise electronics that provide Pulse Width Modulation (PWM) control, Analog to Digital Conversion (ADC), Digital to Analog Conversion (DAC), etc. In addition, all or part of the device specific circuits 101 may reside outside the library controller 100.

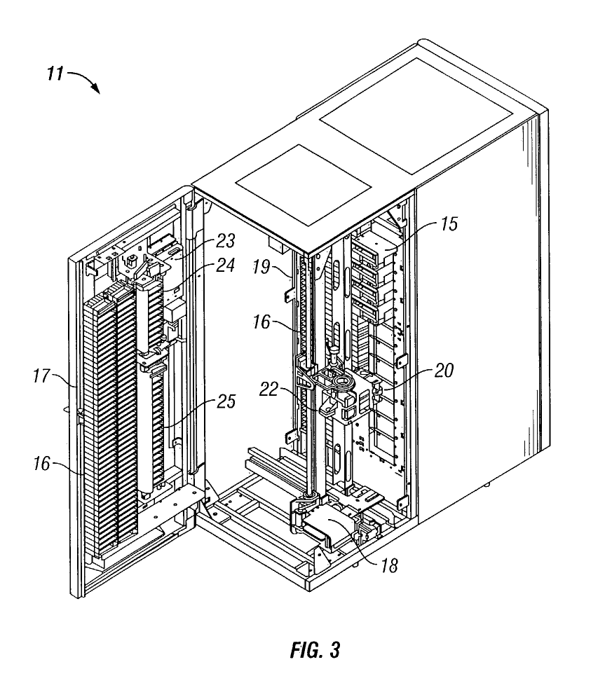

FIG. 2 illustrates an automated data storage library 10 with left hand service bay 13, one or more storage frames 11, and right hand service bay 14. FIG. 3 shows an example of a storage frame 11, which also is the minimum configuration of the library. In this minimum configuration, there is no service bay. The library is arranged for accessing data storage media (not shown) in response to commands from at least one external host system (not shown), and comprises a plurality of storage shelves 16, on front wall 17 and rear wall 19, for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18. As described above, the storage frames 11, may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or reading system, such as a smart card reader or similar system, mounted on the gripper 20, to “read” identifying information about the data storage media.

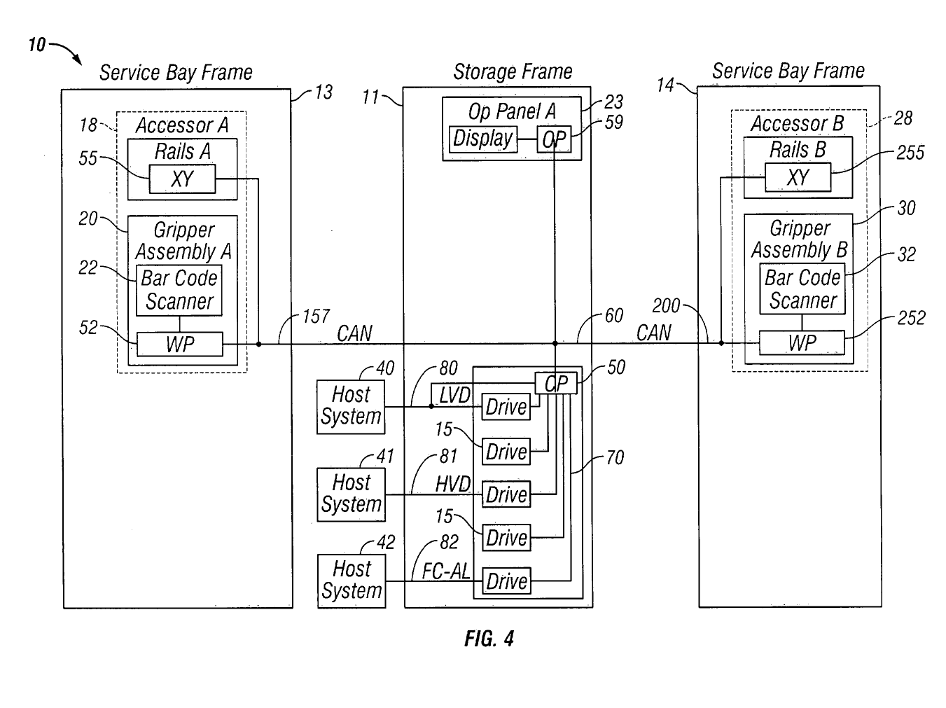

FIG. 4 illustrates an embodiment of a data storage library 10 of FIGS. 2 and 3, which employs a distributed system of modules with a plurality of processor nodes. An example of a data storage library which may implement the present invention is the IBM 3584 UltraScalable Tape Library. The library of FIG. 4 comprises one or more storage frames 11, a left hand service bay 13 and a right hand service bay 14.

The left hand service bay 13 comprises a first accessor 18. As discussed above, the first accessor 18 comprises a gripper assembly 20 and may include a reading system 22 to “read” identifying information about the data storage media. The right hand service bay 14 comprises a second accessor 28. The second accessor 28 comprises a gripper assembly 30 and may include a reading system 32 to “read” identifying information about the data storage media. In the event of a failure or other unavailability of the first accessor 18, or its gripper 20, etc., the second accessor 28 may perform all of the functions of the failed first accessor 18. The first accessor 18 and the second accessor 28 are described as first and second for descriptive purposes only, this description is not meant to limit either accessor to an association with either the left hand service bay 13, or the right hand service bay 14.

In the exemplary library, first accessor 18 or second accessor 28 moves its gripper in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41 or 42. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor node may also direct the operation of first accessor 18, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor node 52, and the XY processor node 55.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other similar networks, such as Ethernet, or a wireless network system, such as RF or infrared, may be employed in the library as is known to those of skill in the art.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 4, host connections 80 and 81 are SCSI busses. Bus 82 comprises an example of a Fiber Channel-Aribitrated Loop which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70.

Additional storage frames 11 may be provided and each is coupled to the adjacent storage frame. Any of the storage frames 11 may comprise communication processor nodes 50, storage shelves 16, data storage drives 15, and networks 60.

Further, the data storage library 10 may additionally comprise a second accessor 28, for example, in a right hand service bay 14. The second accessor 28 may comprise a gripper 30 for accessing the data storage media, and an XY system 255 for moving the second accessor 28 The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 4 and the accompanying description, the first and second accessors are associated with the left hand service bay 13 and the right hand service bay 14. This is for illustrative purposes and there may not be an actual association. In addition, network 157 may not be associated with the left hand service bay 13 and network 200 may not be associated with the right hand service bay 14.

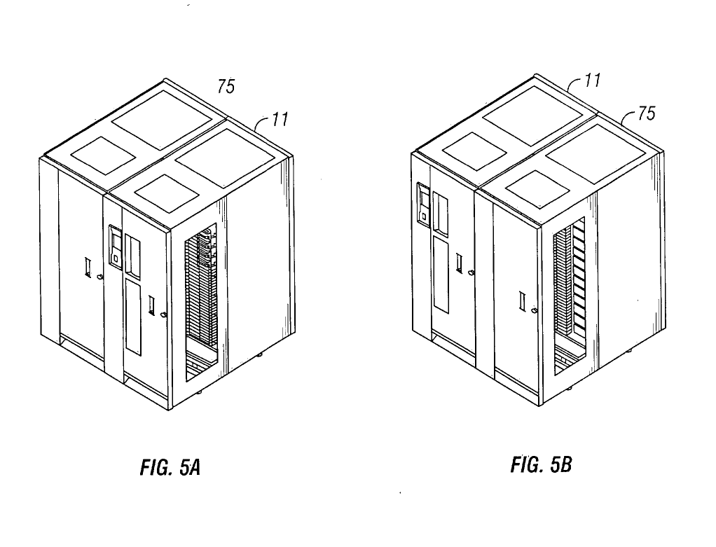

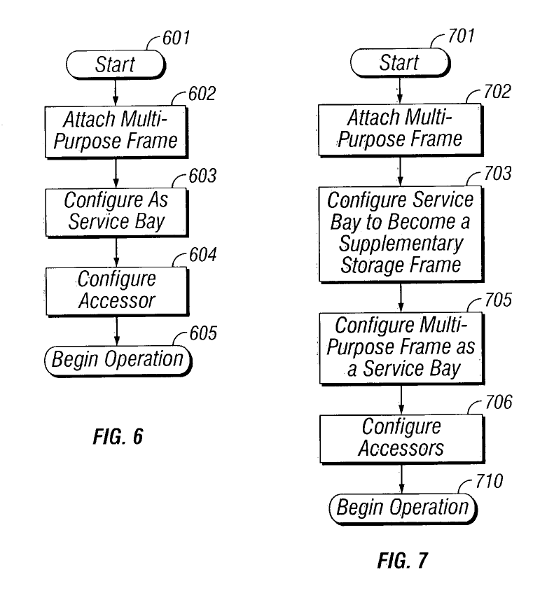

In a first embodiment, the library is expanded from one or more storage frames 11 (FIGS. 2, 3, 4, 5). A flowchart of the steps to expand the library is shown in FIG. 6. Before expansion, the configuration doesn't include a service bay. In this embodiment the library is expanded from one or more storage frames 11, to include a multi-purpose frame 75 (FIG. 5) that will function as a service bay. The multi-purpose frame 75 may be similar in appearance to a storage frame 11. The multi-purpose frame 75 is attached at Step 602 (FIG. 6) to an existing storage frame 11. The multi-purpose frame 75 may be attached to either side of an existing storage frame 11 as illustrated in FIG. 5. The resulting expanded library consists of the multi-purpose frame 75 attached to an existing storage frame 11. FIG. 5 illustrates a configuration that uses only one storage frame 11. If more that one storage frame exists before or after expansion, then the single storage frame 11 of FIG. 5 would be replaced by additional storage frames 11. To complete the expansion and bring the library into operation, the multi-purpose frame 75, first accessor 18 (FIG. 3) and the library controller 100 (FIG. 1) are configured to recognize and use the multi-purpose frame 75 as a service bay. Configuration of the multi-purpose frame 75 to operate as a service bay at step 603, may comprise minor mechanical changes or adjustments such as the removal or installation of special storage shelves for testing and evaluation of the first accessor 18. The first accessor 18 is configured to be moveably disposed throughout all of the frames of the expanded library at step 604. Alternatively, step 604 may be part of step 603. Configuration of first accessor 18 enables the library controller 100 to move first accessor 18 to the multi-purpose frame 75 for service, testing or storage of first accessor 18, or for other purposes necessary for library operation or testing. Service of first accessor 18 may involve replacement or adjustments to some or all of the accessor components. Storage of first accessor 18 may be necessary under a variety of situations where it is necessary to move first accessor 18 away from the storage frame(s) 11. Testing of first accessor 18 may involve measuring the ability of first accessor 18 to handle data storage media cartridges. The configuration that takes place in steps 603 and 604 may comprise a process of discovering, recognizing or learning the presence of physical and/or logical devices or settings that are present in the library. The learning may be accomplished by self discovery by the library controller 100, using sensors and/or communication with devices within the library. Alternatively, the learning may be a process where an operator or an external computer communicates the physical and/or logical configuration changes to the library controller 100. The configuration process could involve the library controller 100 discovering the multi-purpose frame 75 by detecting a different number of frames compared to the previous state before expansion. The library may then read the multi-purpose frame 75 model number and/or serial number from a bar code label or other means of identification on the multi-purpose frame 75. The frame identification label may indicate that the multi-purpose frame 75 is intended to function as a service bay. The library controller 100 could then perform a self configuration based on the information contained in the identification label to accommodate the use of the multi-purpose frame 75 as a service bay automatically, without operator intervention. Various methods of self discovery and labeling may be used to configure the library controller 100 without deviating from the spirit of the present invention.

In a second embodiment, the library is expanded from the configuration of the first embodiment described above to include a second robot accessor 28. The flowchart shown in Fig. 6 of the steps to expand the library for the first embodiment discussed above also applies to the second embodiment, except at step 604 both the first accessor 18 and/or the second accessor 28 are configured to be moveably disposed throughout all of the frames of the expanded library. This enables the multi-purpose frame 75 to be used for storage, service, or testing of either first accessor 18 and/or the second accessor 28. If one of the accessors needs service and is unable to move to the multi-purpose frame 75 then the other accessor may be used to push the failed accessor to the multi-purpose frame 75 for service. This capability allows the library to continue operation with one accessor while the failed accessor is serviced. After the failed accessor is repaired it may also be tested in the multi-purpose frame 75 to verify proper operation. The failed accessor may also be temporarily stored in the multi-purpose frame 75 either before or after service. The multi-purpose frame 75 may function as a service bay for either accessor.

In a third embodiment, the library is expanded from a configuration that includes one or more storage frames 11, one or more service bays, first accessor 18, and second accessor 28. A flowchart of the steps to expand the library is shown in FIG. 7. In this embodiment the library is expanded to include a multi-purpose frame 75 that will function as a service bay. The multi-purpose frame 75 is attached at Step 702 (FIG. 7) to an existing service bay, such as right hand service bay 14 or left hand service bay 13. The resulting expanded library consists of the multi-purpose frame 75 attached to an existing right hand service bay 14 or the left hand service bay 13. To complete the expansion and bring the library into operation, the added and existing library frames, accessors, and the controller are configured for the desired library operation. At step 703 (FIG. 7), either the right hand service bay 14 or the left hand service bay 13 is configured as a supplementary storage frame. A supplementary storage frame operates in an equivalent manner as a storage frame 11 described above. At step 705 (FIG. 7), the multi-purpose frame 75 is configured to operate as a replacement service bay. The replacement service bay operates in an equivalent manner as either the right hand service bay 14 or the left hand service bay 13 described above. At step 706 (FIG. 7), first accessor 18 and/or second accessor 28 are configured to be moveably disposed throughout all of the frames of the expanded library. This enables the multi-purpose frame 75 to be used for storage, service, or testing of either first accessor 18 or second accessor 28. If one of the accessors needs service and is unable to move to the multi-purpose frame 75, then the other accessor may be used to push the failed accessor to the multi-purpose frame 75 for service. This capability allows the library to continue operation with one accessor while the failed accessor is serviced. After the failed accessor is repaired it may also be tested in the multi-purpose frame 75 to verify proper operation. The failed accessor may also be temporarily stored in the multi-purpose frame 75 either before or after service. The multi-purpose frame 75 may function as a service bay for either accessor. The library controller 100 (FIG. 1) is configured to recognize and use the multi-purpose frame 75 as a replacement service bay and to recognize and use the either the right hand service bay 14 or the left hand service bay 13 as a supplementary storage frame. Configuration of the multi-purpose frame 75 to operate as a service bay at step 705, may comprise minor mechanical changes or adjustments such as the removal or installation of special storage shelves for testing and evaluation of accessor 18. Storage of the first accessor 18 and/or second accessor 28 may be necessary under a variety of situations where it is necessary to move one of the accessors away from the storage frame(s) 11. Testing of the accessors may involve measuring the ability of first accessor's 18 and/or second accessor's 28 ability to handle data storage media cartridges. The configuration of any or all of the components may comprise a process of discovering, recognizing or learning the presence of physical and/or logical devices or settings that are present in the library. The learning may be accomplished by self discovery by the library controller 100, using sensors and/or communication with devices within the library. Alternatively, the learning may be a process where an operator or an external computer communicates the physical and/or logical configuration changes to the library controller 100. The configuration process could involve the library controller 100 discovering the multi-purpose frame 75 by detecting a different number of frames compared to the previous state before expansion. The library may then read the multi-purpose frame 75 model number and/or serial number from a bar code label or other means of identification on the multi-purpose frame 75. The frame identification label may indicate that the multi-purpose frame 75 is intended to function as a service bay and that either the right hand service bay 14 or the left hand service bay 13 is intended to function as a supplementary storage frame. The library controller 100 could then perform a self configuration based on the information contained in the identification label to accommodate the use of the multi-purpose frame 75 as a service bay and either the right hand service bay 14 or the left hand service bay 13 as a supplementary storage frame automatically, without operator intervention. Various methods of self discovery and labeling may be used to configure the library controller 100 without deviating from the spirit of the present invention. In another example, the configuration process could involve the discovery of a new frame. If the existing frame that adjoins the new frame was a service bay, then the library controller would configure the new frame as a new service bay and it would configure the previous service bay as an additional storage frame. Additional storage shelves 16, data storage drives 15, or other library components may be attached to the multi-purpose frame 75, or any of the frames of the expanded library. The Additional storage shelves, data storage drives 15, or other library components may be used for normal library operation or for testing purposes such as verifying that either of the accessors described above may access any of the installed components.

Several embodiments and descriptions refer to configuration of an accessor. This may not involve any action or activity within the accessor but may comprise a logical operation that occurs within the operational firmware of the library controller. For example, the library controller may simply record new limits for accessor travel to include any additional frame space.

Several embodiments and descriptions refer to one or more accessors being moveably disposed throughout all of the frames of a library. This is a practical description that is not meant to limit this patent to limitations in the design of a library or accessor. For example, if a first accessor is at an extreme end of travel then a second accessor may bump or collide with the first accessor and not be able to enter the space occupied by the first accessor.

Several embodiments and descriptions refer to a library consisting of one or more storage frames. The storage frame has been described as having optional components such as operator panels, I/O stations, drives, storage, etc. Alternative arrangements may comprise additional frames, such as expansion frames, storage frames, drive frames, etc. One skilled in the art can appreciate that arrangements of different frame types can be more simply described as a storage frame with optional features and this description is not meant to limit the invention to certain classifications of frame types.

Several embodiments and descriptions refer to a service bay as being used for testing, storing or servicing an accessor. One skilled in the art can appreciate the fact that the service bay may also be used for storing data storage media or drives. For example, a service bay that is storing, servicing or testing a first accessor may have enough space for a second accessor to gain access to part or all of the data storage drives and/or storage shelves contained in the service bay.

While the preferred embodiments of the present invention have been illustrated in detail, the skilled artisan will appreciate that modifications and adaptations to those embodiments may be made without departing from the scope of the present invention as set forth in the following claims.

What is claimed is:

1. A method for expanding an automated data storage library having one or more storage frames, a first accessor and a library controller for operating said automated data storage library, where said method comprises the steps of:
attaching a multi-purpose frame to any one of said one or more storage frames;
configuring said library controller to use said multi-purpose frame as a service bay.

2. The method of claim 1 comprising the additional step of:
configuring said first accessor to be moveably disposed throughout said one or more storage frames and said multi-purpose frame.

3. The method of claim 1 comprising the additional steps of:
moving said first accessor to said multi-purpose frame; and
servicing said first accessor in said multi-purpose frame.

4. The method of claim 1 comprising the additional steps of:
moving said first accessor to said multi-purpose frame; and
storing said first accessor in said multi-purpose frame.

5. The method of claim 1, comprising the additional steps of:
attaching a second accessor to said automated data storage library; and
configuring said second accessor to be moveably disposed throughout said one or more storage frames and said multi-purpose frame.

6. The method of claim 5, comprising the additional steps of:
moving said second accessor to said multi-purpose frame; and
servicing said second accessor in said multi-purpose frame.

7. The method of claim 5, comprising the additional steps of:
moving said second accessor to said multi-purpose frame; and
storing said second accessor in said multi-purpose frame.

8. A method for expanding an automated data storage library having one or more storage frames, a first accessor, a second accessor, a service bay for servicing or storing said first accessor and a library controller for operating said automated data storage library, where said method comprises the steps of:
attaching a multi-purpose frame to said service bay;
configuring said library controller to use said service bay as a supplementary storage frame and;
configuring said library controller to use said multi-purpose frame as a replacement service bay.

9. The method of claim 8, comprising the additional steps of:
attaching additional storage shelves to said multi-purpose frame;
moving said first accessor to said multi-purpose frame; and
verifying that said first accessor can access said additional storage shelves.

10. An expanded automated data storage library comprising:
one or more storage frames having a plurality of storage shelves for storing data storage cartridges;
a first accessor used for transporting said data storage cartridges;
a multi-purpose frame attached to any one of said one or more storage frames;
a library controller for operating said automated data storage library, wherein said library controller is configured to use said multi-purpose frame as a service bay.

11. The expanded automated data storage library of claim 10, wherein said first accessor is moveably disposed throughout said one or more storage frames and said multi-purpose frame.

12. The expanded automated data storage library of claim 10, wherein said multi-purpose frame holds said first accessor during servicing of said first accessor.

13. The expanded automated data storage library of claim 10, wherein said multi-purpose frame holds said first accessor during storage of said first accessor.

14. The expanded automated data storage library of claim 10, further comprising:
a second accessor moveably disposed throughout said one or more storage frames and said multi-purpose frame.

15. The expanded automated data storage library of claim 14, wherein said multi-purpose frame holds said second accessor during servicing of said second accessor.

16. The expanded automated data storage library of claim 14, wherein said multi-purpose frame holds said second accessor during storage of said second accessor.

17. An expanded automated data storage library, comprising:
one or more storage frames having a plurality of storage shelves for storing data storage cartridges;
a first accessor, said first accessor used for transporting said data storage cartridges;
a second accessor, said second accessor used for transporting said data storage cartridges;
a service bay for servicing or storing said first accessor;
a multi-purpose frame attached to said service bay;
a library controller for operating said automated data storage library, wherein said library controller is configured to use said service bay as a supplementary storage frame and said library controller is configured to use said multi-purpose frame as a replacement service bay.

18. The expanded automated data storage library of claim 17, further comprising:
additional storage shelves attached to said multi-purpose frame, wherein said library controller moves said first accessor to said multi-purpose frame and verifies that said first accessor can access said additional storage shelves.

19. A computer program product on a computer-readable medium usable with a programmable computer, said computer program product having computer readable program code embodied therein for expanding an automated data storage library having one or more storage frames, a first accessor, a multi-purpose frame attached to any one of said one or more storage frames and a library controller for operating said automated data storage library, where said computer program product comprises:
computer readable program code which causes said controller to use said multi-purpose frame as a service bay.

20. The computer program product of claim 19, further comprising:
computer readable program code which causes said first accessor to be moveably disposed throughout said one or more storage frames and said multi-purpose frame.

21. The computer program product of claim 19, further comprising:
computer readable program code which causes the moving of said first accessor to said multi-purpose frame for servicing of said first accessor.

22. The computer program product of claim 19, further comprising:
computer readable program code which causes the moving of said first accessor to said multi-purpose frame for storage of said first accessor.

23. The computer program product of claim 19, wherein said automated data storage library includes a second accessor, said computer program product further comprising:
computer readable program code which causes said second accessor to be moveably disposed throughout said one or more storage frames and said multi-purpose frame.

24. The computer program product of claim 23, further comprising:
computer readable program code which causes the moving of said second accessor to said multi-purpose frame for servicing of said second accessor.

25. The computer program product of claim 23, further comprising:
computer readable program code which causes the moving of said second accessor to said multi-purpose frame for storage of said second accessor.

26. A computer program product on a computer-readable medium usable with a programmable computer, said computer program product having computer readable program code embodied therein for expanding an automated data storage library having one or more storage frames, a first accessor, a second accessor, a service bay for servicing or storing said first accessor, a multi-purpose frame attached to said service bay and a library controller for operating said automated data storage library, where said computer program product comprises:
computer readable program code which causes said library controller to use said service bay as a supplementary storage frame and;
computer readable program code which causes said library controller to use said multi-purpose frame as a replacement service bay.

27. The computer program product of claim 26, wherein additional storage shelves are attached to said multi-purpose frame, said computer program product further comprising:
computer readable program code which causes the moving of said first accessor to said multi-purpose frame; and
computer readable program code which causes said first accessor to access said additional storage shelves.
